(19) United States
(12) Patent Application Publication
(10) Pub. No.: US 2026/0254676 A1
(43) Pub. Date: Aug. 27, 2026

(54) INFORMATION PROCESSING DEVICE

(71) Applicant: TOYOTA JIDOSHA KABUSHIKI KAISHA, Toyota-shi (JP)

(72) Inventor: Naoya OKAMURA, Toyota-shi (JP)

(73) Assignee: TOYOTA JIDOSHA KABUSHIKI KAISHA, Toyota-shi (JP)

(21) Appl. No.: 19/390,625

(22) Filed: Nov. 16, 2025

(30) Foreign Application Priority Data
Feb. 26, 2025 (JP) 2025-028938

(51) Int. Cl. H04L 12/40

(52) U.S. Cl. CPC H04L 12/40189; H04L 2012/40273

(57) ABSTRACT

The execution device transmits, from the first communication port via the first communication bus to the counterpart device, the data set. When the signal indicating that the reception of the target data is completed is not received from the counterpart device via the first communication bus before the specified time elapses after the data set has been transmitted, the execution device transmits, from the second communication port via the second communication bus to the counterpart device, the data set.

### CROSS-REFERENCE TO RELATED APPLICATION

This application claims priority to Japanese Patent Application No. 2025-028938 filed on February 26, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

Japanese Unexamined Patent Application Publication No. 2009-116642 (JP 2009-116642 A) discloses an information processing device that communicates using a peripheral component interconnect (PCI) bus. The information processing device recovers from a PCI bus failure.

### SUMMARY

In the information processing device as described in JP 2009-116642 A, a failure may occur in the bus. In such a case, the information processing device may, for a certain period, be unable to transmit target data to be transmitted to a counterpart device that is a transmission destination via the bus in which the failure has occurred. Therefore, the timing at which the target data reaches the counterpart device that is the transmission destination is delayed.

An information processing device for solving the above problems is an information processing device configured to perform mutual communication with a counterpart device via a first communication bus, and to perform mutual communication with the counterpart device via a second communication bus different from the first communication bus.

The information processing device includes:

a first communication port to which the first communication bus is connected;

a second communication port to which the second communication bus is connected;

an execution device; and

a storage device.

The execution device is configured to execute:

transmitting, from the first communication port via the first communication bus to the counterpart device, a data set including target data that is a transmission target among data stored in the storage device, and a signal requesting a reply when reception of the target data is completed; and

when a signal indicating that the reception of the target data is completed is not received from the counterpart device via the first communication bus before a specified time determined in advance elapses after the data set has been transmitted, transmitting, from the second communication port via the second communication bus to the counterpart device, the data set.

Even when an abnormality occurs in communication via the first communication bus, the information processing device can suppress the delay in the timing at which the target data reaches the counterpart device by communicating via the second communication bus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle including a communication system of an embodiment;

FIG. 2 is a flowchart showing a series of processes executed by the execution device of the information processing device of the embodiment; and

FIG. 3 is a schematic diagram showing the data set of the embodiment.

### DETAILED DESCRIPTION OF EMBODIMENTS

### Embodiment

Hereinafter, the embodiment of the information processing device will be described with reference to the drawings.

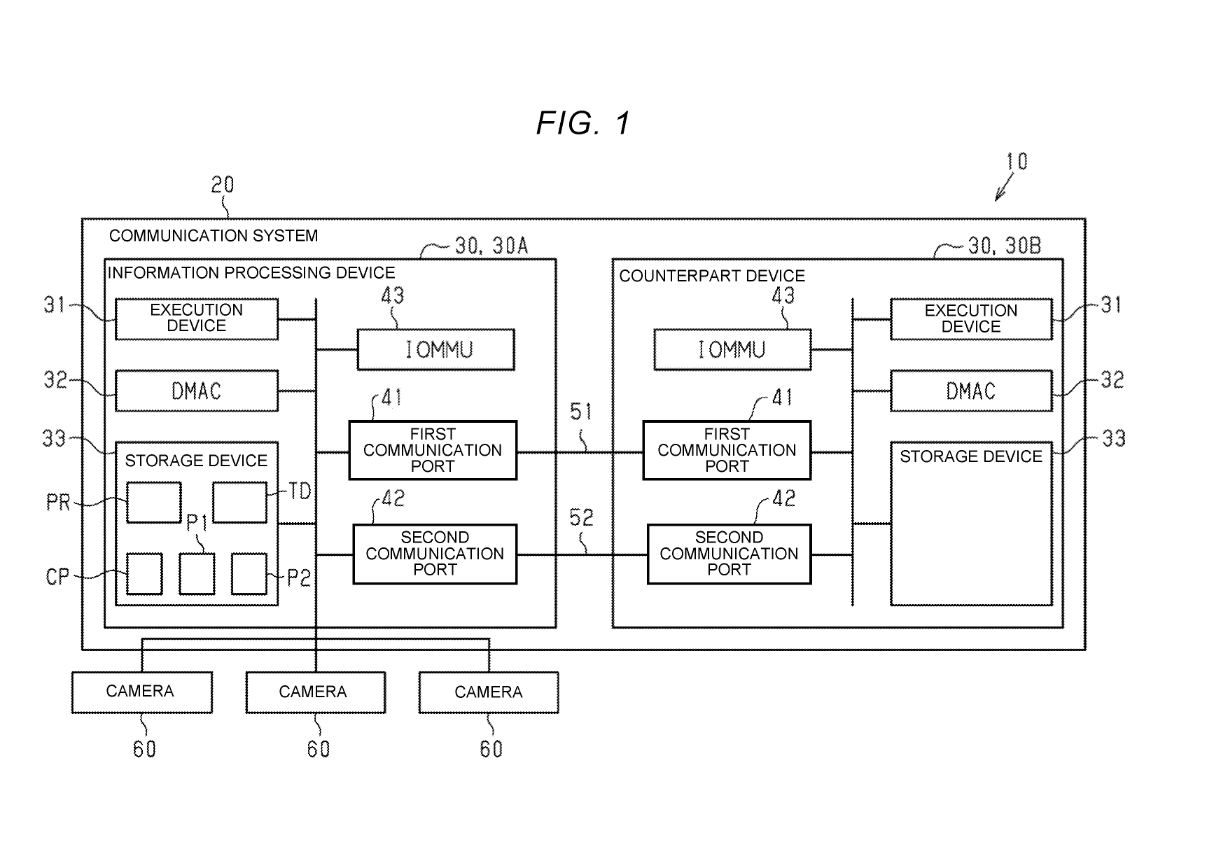

As shown in FIG. 1, the vehicle 10 includes a communication system 20 and a plurality of cameras 60. The communication system 20 acquires signals from respective switches of the vehicle 10 and controls respective actuators of the vehicle 10 based on the acquired signals.

The communication system 20 includes a plurality of communication devices 30. The communication devices 30 can perform mutual communication with each other in accordance with the PCIe standard via the first communication bus 51. PCIe is an abbreviation for Peripheral Component Interconnect Express. The communication devices 30 can perform mutual communication with each other in accordance with the PCIe standard via a second communication bus 52 different from the first communication bus 51.

The communication device 30 is an ECU that controls the respective actuators provided in the vehicle 10 and performs computational processing based on values acquired from the respective sensors provided in the vehicle 10. For example, one of the communication devices 30 is a camera ECU. The camera ECU acquires images from the cameras 60 of the vehicle 10 and performs computational processing to synthesize the images acquired from the cameras 60 into one image. In addition, for example, one of the communication devices 30 is an ADAS ECU. ADAS is an abbreviation for Advanced Driver Assistance Systems. The ADAS ECU performs computational processing to implement the advanced safety function based on the time-series data of the images acquired from the camera ECU. The advanced safety function is, for example, an adaptive cruise control system (ACC), a forward collision warning (FCW), or the like.

In the present embodiment, the communication devices 30 are two, that is, the information processing device 30A and the counterpart device 30B. The information processing device 30A is the camera ECU, and the counterpart device 30B is the ADAS ECU. Therefore, the information processing device 30A can perform mutual communication with the counterpart device 30B via the first communication bus 51, and can perform mutual communication with the counterpart device 30B via the second communication bus 52.

The information processing device 30A functions as an endpoint. On the other hand, the counterpart device 30B functions as a root complex. As a result, the information processing device 30A performs mutual communication with the counterpart device 30B in accordance with the PCIe standard.

The communication device 30 includes the execution device 31, the direct memory access control device 32, the storage device 33, the first communication port 41, the second communication port 42, and an input/output memory management unit (IOMMU) 43. The execution device 31 is a CPU. Therefore, the execution device 31 includes a processing circuit. The execution device 31 instructs the direct memory access control device 32 to execute direct memory access control to transmit the target data TD to the counterpart device 30B. The execution device 31 executes various computations and controls by executing various programs stored in the storage device 33. For example, in a case where the communication device 30 is the camera ECU, the execution device 31 executes computation to synthesize the images acquired from the cameras 60.

The direct memory access control device 32 is a so-called direct memory access controller (DMAC). The direct memory access control device 32 is a dedicated CPU for executing the direct memory access control. The direct memory access control is a control of transmitting data such that the data stored in the storage device 33 is stored to the storage device 33 of another communication device 30 that performs mutual communication with the communication device 30.

The storage device 33 of the information processing device 30A stores a transmission program PR, the target data TD, a first parameter P1, a second parameter P2, and a counter value CP. The transmission program PR is a program executed by the execution device 31, and is a program for causing the execution device 31 to execute a series of processes including the transmission of the target data TD.

The target data TD is data to be transmitted by the information processing device 30A to the counterpart device 30B. The target data TD is data for which a deadline for completing the transmission of the target data TD is determined. That is, the target data TD is data for which real-time communication is requested. Specifically, the target data TD is the time-series data of the image synthesized from the images acquired by the information processing device 30A from the cameras 60.

The first parameter P1 is a parameter indicating a communication state with the counterpart device 30B via the first communication bus 51 using the first communication port 41. The first parameter P1 has a value indicating a connected state in which communication can be performed or a value indicating a disconnected state in which communication cannot be performed.

The second parameter P2 is a parameter indicating a communication state with the counterpart device 30B via the second communication bus 52 using the second communication port 42. The second parameter P2 has a value indicating a connected state in which communication can be performed or a value indicating a disconnected state in which communication cannot be performed.

The counter value CP is a parameter that determines the value of the "#" in the Done# transmitted between the information processing device 30A and the counterpart device 30B, as will be described later. The counter value CP is an integer of 0 or more.

The first communication port 41 is connected to the first communication bus 51. The first communication port 41 transmits and receives data when mutual communication is performed. The first communication port 41 has a three-layer structure including a transaction layer, a data link layer, and a physical layer.

The transaction layer ensures reliable end-to-end communication of data for an upper software layer that includes an upper-layer driver and application software. The data link layer is positioned between the transaction layer and the physical layer. The data link layer performs flow control. In the flow control, the data link layer limits the transmission speed according to the reception processing speed of the communication devices 30 that perform mutual communication with each other. The physical layer transmits and receives packets for communication over a physical medium.

The second communication port 42 is a port different from the first communication port 41. The second communication port 42 is connected to the second communication bus 52. The second communication port 42 transmits and receives data when mutual communication is performed. The second communication port 42 has the three-layer structure, similar to that of the first communication port 41.

In the present embodiment, the first communication port 41 of the information processing device 30A is connected to the first communication port 41 of the counterpart device 30B via the first communication bus 51. The second communication port 42 of the information processing device 30A is connected to the second communication port 42 of the counterpart device 30B via the second communication bus 52.

The IOMMU 43 converts addresses included in various requests from another communication device 30 that performs mutual communication with the communication device 30. Specifically, the IOMMU 43 of the information processing device 30A converts the address used by the counterpart device 30B into the address used internally by the information processing device 30A.

Therefore, the IOMMU 43 of the counterpart device 30B can recognize whether the signal has been acquired from the first communication port 41 or from the second communication port 42 when the signal is acquired. As a result, the counterpart device 30B can return the reception completion signal MS to be described later via the port that acquired the signal requesting a reply.

### Series of Processes Related to Transmission of Target Data

Hereinafter, a series of processes related to the transmission of the target data TD executed by the execution device 31 of the information processing device 30A to transmit the target data TD from the information processing device 30A to the counterpart device 30B will be described.

When the information processing device 30A transmits the target data TD via real-time communication, the execution device 31 of the information processing device 30A starts executing the transmission program PR.

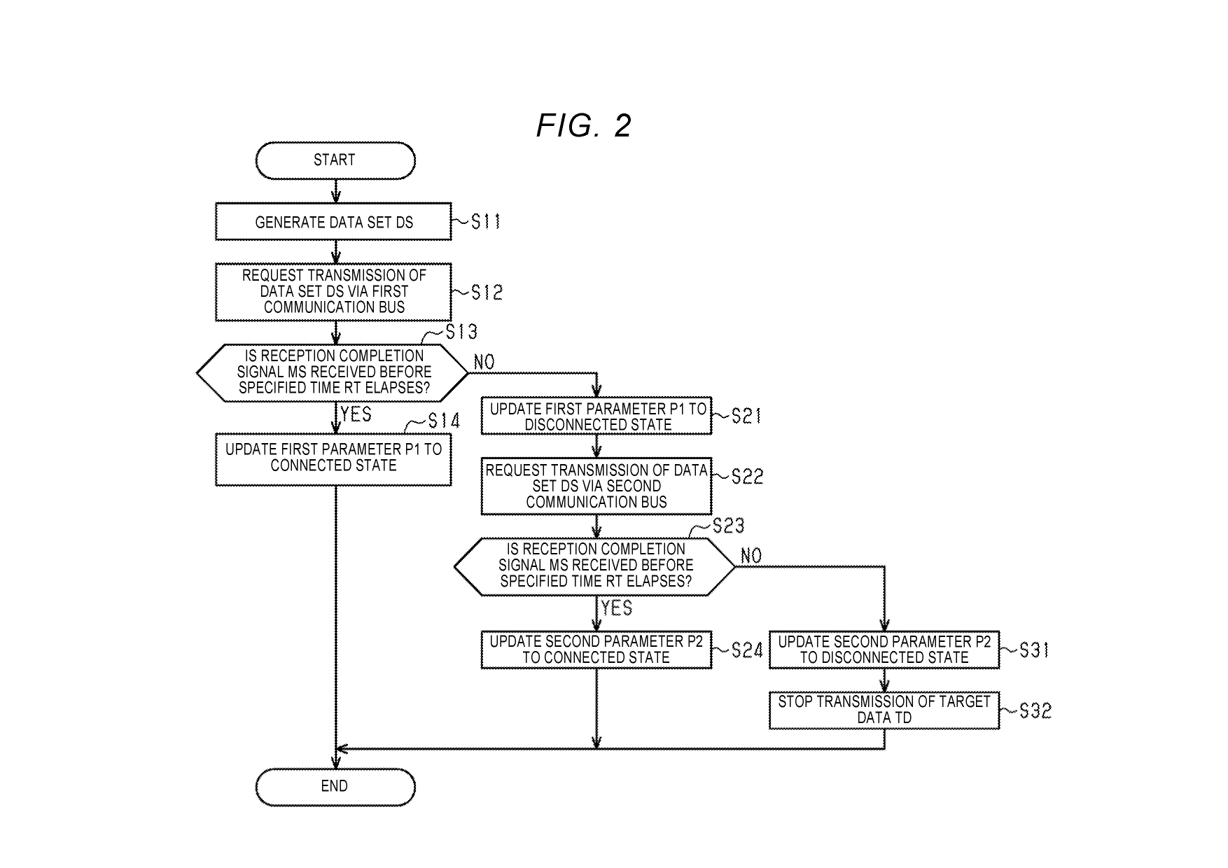

As shown in FIG. 2, when the execution device 31 starts executing the transmission program PR, the execution device 31 first executes the process of S11. In S11, the execution device 31 generates the data set DS.

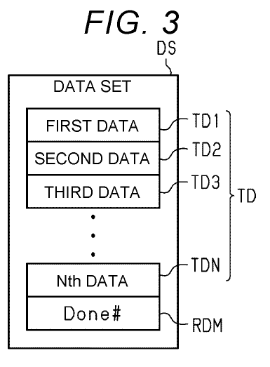

As shown in FIG. 3, the data set DS includes the target data TD and a reply request signal RDM that requests a reply when the reception of the target data TD is completed. The target data TD includes first data TD1 to Nth data TDN as N pieces of data for a time determined in advance. The target data TD is accompanied by a write signal that is a write request to an address of the storage device 33 of the counterpart device 30B.

The reply request signal RDM is a Done#. The "#" has a value obtained by incrementing the counter value CP of the "#" stored in the storage device 33 by one. When the execution device 31 generates the reply request signal RDM, the execution device 31 refers to the counter value CP of the "#" stored in the storage device 33. The Done# is accompanied by a write signal that is a write request to an address of the storage device 33 of the information processing device 30A. That is, the reply request signal RDM is a signal requesting, through the IOMMU 43 of the counterpart device 30B, that a reply be transmitted via the first communication bus 51 used to transmit the data set DS.

As shown in FIG. 2, after the execution device 31 creates the data set DS, the execution device 31 advances the process to S12. In S12, the execution device 31 requests the direct memory access control device 32 to transmit the data set DS from the first communication port 41 via the first communication bus 51. As a result, the direct memory access control device 32 transmits the data set DS from the first communication port 41 via the first communication bus 51 to the counterpart device 30B. Thereafter, the execution device 31 advances the process to S13.

In S13, the execution device 31 determines whether the first communication port 41 has received the reception completion signal MS via the first communication bus 51 before a specified time RT determined in advance elapses after the process of S12 is executed. The specified time RT is a time determined in advance to be sufficient to obtain a reply from the counterpart device 30B when communication can be performed normally through tests or simulations. The reception completion signal MS is a signal indicating that the counterpart device 30B has completed the reception of the target data TD included in the data set DS. Specifically, the reception completion signal MS is a Done# included in the data set DS.

Specifically, when the first communication port 41 of the information processing device 30A receives the Done# as the reception completion signal MS transferred from the counterpart device 30B, the IOMMU 43 of the information processing device 30A specifies the address of the write destination of the Done#. When the storage device 33 of the information processing device 30A is specified as the write destination of the Done#, the IOMMU 43 of the information processing device 30A writes the Done# into the storage device 33. As a result, the counter value CP stored in the storage device 33 is updated to a value incremented by one. Therefore, when the information processing device 30A receives the reply from the counterpart device 30B after transmitting the data set DS, the value of the "#" is incremented by one and updated.

In S13, the execution device 31 refers to the counter value CP stored in the storage device 33, and determines that the reception completion signal MS has been received when the counter value CP is updated to a value incremented by one before the specified time RT elapses. On the other hand, the execution device 31 refers to the counter value CP stored in the storage device 33, and determines that the reception completion signal MS has not been received when the counter value CP is not updated to a value incremented by one before the specified time RT elapses.

When the first communication port 41 receives the reception completion signal MS before the specified time RT elapses (S13: YES), the execution device 31 advances the process to S14. In S14, the execution device 31 determines that the communication state with the counterpart device 30B via the first communication bus 51 using the first communication port 41 is normal. Then, the execution device 31 updates the first parameter P1 indicating the connected state with the counterpart device 30B via the first communication bus 51 to the connected state in which the communication can be performed. Thereafter, the execution device 31 ends the present series of processes.

On the other hand, when the first communication port 41 does not receive the reception completion signal MS before the specified time RT elapses (S13: NO), the execution device 31 advances the process to S21. In S21, the execution device 31 determines that the communication state with the counterpart device 30B via the first communication bus 51 using the first communication port 41 is abnormal. Then, the execution device 31 updates the first parameter P1 indicating the connected state with the counterpart device 30B via the first communication bus 51 to the value indicating the disconnected state in which the communication cannot be performed. Thereafter, the execution device 31 advances the process to S22.

In S22, the execution device 31 requests the direct memory access control device 32 to transmit the data set DS generated in S11 from the second communication port 42 via the second communication bus 52. As a result, the direct memory access control device 32 transmits the data set DS from the second communication port 42 via the second communication bus 52 to the counterpart device 30B. Thereafter, the execution device 31 advances the process to S23.

In S23, the execution device 31 determines whether the second communication port 42 has received the reception completion signal MS via the second communication bus 52 before the specified time RT elapses after the process of S22 is executed.

When the second communication port 42 receives the reception completion signal MS before the specified time RT elapses (S23: YES), the execution device 31 advances the process to S24. In S24, the execution device 31 determines that the communication state with the counterpart device 30B via the second communication bus 52 using the second communication port 42 is normal. Then, the execution device 31 updates the second parameter P2 indicating the connected state with the counterpart device 30B via the second communication bus 52 to the connected state in which the communication can be performed. Thereafter, the execution device 31 ends the present series of processes.

On the other hand, when the second communication port 42 does not receive the reception completion signal MS before the specified time RT elapses (S23: NO), the execution device 31 advances the process to S31. In S31, the execution device 31 determines that the communication state with the counterpart device 30B via the second communication bus 52 using the second communication port 42 is abnormal. Then, the execution device 31 updates the second parameter P2 indicating the connected state with the counterpart device 30B via the second communication bus 52 to the value indicating the disconnected state in which the communication cannot be performed. Thereafter, the execution device 31 advances the process to S32.

In S32, the execution device 31 stops the transmission of the target data TD needed for the real-time communication. Thereafter, the execution device 31 ends the present series of processes.

The first parameter P1 is a value indicating the disconnected state and the second parameter P2 is a value indicating the connected state. In this case, until the first parameter P1 is updated to the connected state, the information processing device 30A communicates with the counterpart device 30B from the second communication port 42 via the second communication bus 52. When the predetermined restoration process is completed, the first parameter P1 is updated from the value indicating the disconnected state to the value indicating the connected state.

### Operation of Present Embodiment

A case where communication via the first communication bus 51 is normally performed in the communication system 20 will be described. When the data set DS is transmitted from the information processing device 30A to the counterpart device 30B via the first communication bus 51, the IOMMU 43 of the counterpart device 30B transfers the target data TD to the storage device 33 and transfers the Done# to the first communication port 41. The target data TD transferred to the storage device 33 is stored in the storage device 33 by being written to the storage device 33. The Done# transferred to the first communication port 41 is transmitted to the information processing device 30A via the first communication bus 51 as the reception completion signal MS. Then, when the information processing device 30A receives the Done# as the reception completion signal MS, the information processing device 30A updates the counter value CP. In this case, the target data TD is normally received by the counterpart device 30B, and the execution device 31 recognizes that the target data TD has been normally received by the counterpart device 30B.

Next, in the communication system 20, a case will be described in which the communication via the first communication bus 51 is not normally performed because a failure has occurred in the first communication port 41 of the information processing device 30A. The direct memory access control device 32 transmits the data set DS from the first communication port 41 via the first communication bus 51 to the counterpart device 30B. However, since the data set DS does not reach the counterpart device 30B, the IOMMU 43 cannot transfer the target data TD to the storage device 33 and the Done# to the first communication port 41, respectively. As a result, the target data TD is not stored in the counterpart device 30B. In addition, the Done# as the reception completion signal MS is not transmitted from the counterpart device 30B to the information processing device 30A. Therefore, by making a negative determination in S13, the information processing device 30A transmits the data set DS from the second communication port 42 via the second communication bus 52. As a result, the data set DS is transmitted from the information processing device 30A to the counterpart device 30B via the second communication bus 52. When the communication via the second communication bus 52 is normally performed, the counterpart device 30B receives the data set DS. Thereafter, the target data TD is stored in the storage device 33, and the Done# is transmitted to the information processing device 30A from the second communication port 42 via the second communication bus 52 as the reception completion signal MS. In this case, the target data TD is normally received by the counterpart device 30B, and the information processing device 30A recognizes that the target data TD has been normally received by the counterpart device 30B.

### Effects of Present Embodiment

(1) Even when an abnormality occurs in the communication via the first communication bus 51, the information processing device 30A transmits the target data TD via the second communication bus 52. As a result, it is possible to suppress the excessive delay in the timing at which the target data TD reaches the counterpart device 30B.
(2) The storage device 33 stores the first parameter P1 indicating the connected state with the counterpart device 30B via the first communication bus 51. When the execution device 31 does not receive the reception completion signal MS from the counterpart device 30B via the first communication bus 51 before the specified time RT elapses after the data set DS has been transmitted, the execution device 31 updates the first parameter P1 to a value indicating the disconnected state. Therefore, the information processing device 30A can recognize whether the communication with the counterpart device 30B via the first communication bus 51 is possible by referring to the first parameter P1.
(3) When the reception completion signal MS is not received after the data set DS has been transmitted to the counterpart device 30B via the first communication bus 51, the execution device 31 transmits the data set DS to the counterpart device 30B via the second communication bus 52. Thereafter, when the second communication port 42 does not receive the reception completion signal MS from the counterpart device 30B before the specified time RT elapses, the execution device 31 stops the transmission of the target data TD. When neither communication via the first communication bus 51 nor communication via the second communication bus 52 can be performed, the information processing device 30A stops the transmission of the target data TD. As a result, the information processing device 30A can avoid retransmitting an excessive amount of data to the first communication bus 51 and the second communication bus 52.
(4) The target data TD is data for which a deadline for completing the transmission of the target data TD is determined. The information processing device 30A can suppress the excessive delay in the timing at which the target data TD reaches the counterpart device 30B when the information processing device 30A performs the communication for which the deadline for completing the transmission of the target data TD is determined, that is, the real-time communication.
(5) The reply request signal RDM is a signal requesting, through the IOMMU 43 of the counterpart device 30B, that a reply be transmitted via the first communication bus 51 used to transmit the data set DS. With the above configuration, for example, the reception completion signal MS can be quickly acquired by using the function of the IOMMU 43 without executing the process by the execution device 31 of the counterpart device 30B. Therefore, since the specified time RT can be set sufficiently short, it is possible to suppress the excessive increase in the time needed for the information processing device 30A to confirm the reception of the reception completion signal MS due to the excessive increase in the specified time RT.

### Modification

The embodiment described above can be modified and carried out as follows. The embodiment described above and the following modification can be carried out in combination within a technically consistent range.

The storage device 33 of the information processing device 30A need not store the first parameter P1. In addition, the execution device 31 may omit the processes of S14 and S21.

The storage device 33 of the information processing device 30A need not store the second parameter P2. In addition, the execution device 31 may omit the processes of S24 and S31.

The execution device 31 need not execute the process of S32. That is, when the reception completion signal MS is not received from the counterpart device 30B via the second communication bus 52, the execution device 31 need not execute a process of stopping the transmission of the target data TD.

The target data TD need not be data for which a deadline for completing the transmission of the target data TD is determined. That is, the target data TD is not limited to the data used for the real-time communication.

The reply request signal RDM need not be a signal requesting, through the IOMMU 43 of the counterpart device 30B, that a reply be transmitted via the first communication bus 51 used to transmit the data set DS. For example, the reply request signal RDM may be a signal requesting the execution device 31 of the counterpart device 30B to transmit a reply.

The ECUs of the information processing device 30A and the counterpart device 30B are not limited to the examples of the embodiment. The information processing device 30A may be, for example, an engine ECU or a multimedia ECU as long as the information processing device 30A is a communication device that performs mutual communication with the counterpart device 30B. Similarly, the counterpart device 30B may be, for example, a body ECU or a memory card as long as the counterpart device 30B is a communication device that performs mutual communication with the information processing device 30A.

When the execution device 31 makes a negative determination in the process of S13, the execution device 31 may transmit a signal requesting retransmission of the reception completion signal MS to the counterpart device 30B before the process of S21. Thereafter, when the first communication port 41 receives the reception completion signal MS in response to the retransmission request from the counterpart device 30B, the execution device 31 may advance the process to S14.

The information processing device 30A may be configured as a circuit (circuitry) including one or more processors that execute various types of processing in accordance with a computer program (software). The information processing device 30A may be configured as a circuit including one or more dedicated hardware circuits, such as an application-specific integrated circuit (ASIC), which executes at least a part of various types of processing, or a combination thereof. The processor includes a CPU and a memory, such as a RAM and a ROM. The memory stores a program code or an instruction configured to cause the CPU to execute the processing. The memory, that is, a computer-readable medium includes any usable medium accessible by a general-purpose or dedicated computer. In this regard, the same applies to the counterpart device 30B.

What is claimed is:

1. An information processing device configured to perform mutual communication with a counterpart device via a first communication bus, and to perform mutual communication with the counterpart device via a second communication bus different from the first communication bus, the information processing device comprising:
a first communication port to which the first communication bus is connected;
a second communication port to which the second communication bus is connected;
an execution device; and
a storage device, wherein
the execution device is configured to execute:
transmitting, from the first communication port via the first communication bus to the counterpart device, a data set including target data that is a transmission target among data stored in the storage device, and a signal requesting a reply when reception of the target data is completed; and
when a signal indicating that the reception of the target data is completed is not received from the counterpart device via the first communication bus before a specified time determined in advance elapses after the data set has been transmitted, transmitting, from the second communication port via the second communication bus to the counterpart device, the data set.

2. The information processing device according to claim 1, wherein:
the storage device is configured to store a parameter indicating a connected state with the counterpart device via the first communication bus; and
the execution device is configured to execute updating the parameter to a value indicating a disconnected state in which communication is unable to be performed when the signal indicating that the reception of the target data is completed is not received from the counterpart device via the first communication bus before the specified time elapses after the data set has been transmitted.

3. The information processing device according to claim 1, wherein the execution device is configured to execute stopping the transmitting the target data when the signal indicating that the reception of the target data is completed is not received from the counterpart device via the second communication bus before the specified time elapses after the data set has been transmitted to the counterpart device via the second communication bus.

4. The information processing device according to claim 1, wherein the target data is data for which a deadline for completing the transmitting the target data is determined.

5. The information processing device according to claim 1, wherein the signal requesting the reply when the reception of the target data is completed is a signal requesting, through an IOMMU of the counterpart device, that the reply be transmitted via the first communication bus used to transmit the data set.
